(19) United States
(12) Patent Application Publication
(10) Pub. No.: US 2021/0187586 A1
(43) Pub. Date: Jun. 24, 2021

(54) Device and Method for De-Stacking Planar Parts

(71) Applicant: Schuler Pressen GmbH, Goeppingen (DE)

(72) Inventor: Reiner Dörner, Eppingen (DE)

(21) Appl. No.: 17/271,903

(22) PCT Filed: Aug. 28, 2018
(86) PCT No.: PCT/EP2018/073089

§ 371 Date: Feb. 26, 2021

(51) Int. Cl. B21D 43/24; B25J 15/06; B65G 47/91; B65G 59/04

(52) U.S. Cl. CPC B21D 43/24; B25J 15/0616; B65G 2201/022; B65G 59/045; B65G 47/918

(57) ABSTRACT

An apparatus for unstacking plate-like parts with at least one supply station, in which at least one part stack of plate-like parts is located and with an unstacking device which is assigned to the supply station and is for the singularised unstacking of the part stack and for bringing an unstacked part along a run-through direction onto a function station which is arranged downstream. The unstacking device includes a carrier device with at least one runner rail which is aligned along the run-through direction and on which an unstacking slide is movably guided in the run-through direction between the supply station and the function station. The unstacking slide includes a carrier structure on which several gripping units are arranged. The gripping units each include at least one gripping head which can be moved in the height direction for lifting the parts out of the part stack.

### CROSS-REFERENCE TO RELATED APPLICATIONS

This application is the United States national phase of International Application No. PCT/EP2018/073089 filed Aug. 28, 2018, the disclosure of which is hereby incorporated by reference in its entirety.

### BACKGROUND

### Field

The invention relates to an apparatus for unstacking plate-like parts, in particular sheet metal blanks, with at least one supply station, in which at least one part stack of plate-like parts is located and with an unstacking device which is assigned to the supply station, for the singularised unstacking of the part stack and for bringing an unstacked part along a run-through direction onto a function station which is arranged downstream, wherein the unstacking device comprises a carrier device with at least one runner rail which is aligned along a run-through direction and on which an unstacking slide is movably guided in the run-through direction between the supply station and the function station, wherein the unstacking slide comprises a carrier structure, on which several gripping units are arranged, wherein the gripping units each comprise at least one gripping head which can be moved in the height direction for lifting the parts out of the part stack.

### Related Art

An apparatus of the initially mentioned type is known for example from DE 101 17 607 B4. The unstacking apparatus which is described there comprises several gripping units in the form of suction grippers, to which a linear drive is assigned. The linear drives are arranged in a stationary manner above the part stack, so that the lifted parts can be moved exclusively in the height direction by the linear drives. An endlessly circulating transport belt, on which adhesion devices with suction heads are arranged and circulate together with the transport belt, is located on the beam, on which the linear drives are also fastened in a stationary manner. On lifting up the uppermost part of the part stack by way of the linear drives and the suction heads which are connected to these, the lifted part with its region which is located next to the suction heads gets below the adhesion device of the transport belt and is so to speak taken over by these.

Another system for unstacking plate-like parts is disclosed in EP 2 195 267 A1, concerning which robots which act alternately access the part stack and ensure the unstacking, wherein the robots are cycled such that one of the robots removes the uppermost stack from the part stack whilst the other robot deposits an already lifted part onto a conveying belt for the further transport, for example to a function station which is arranged downstream and with regard to which it can be a centring station.

Furthermore, apparatus for unstacking plate-like parts, for example sheet metal blanks are known, concerning which an unstacking slide, a so-called feeder, is movably guided on a carrier unit and for lifting the uppermost part can be traversed over the part stack and whose gripping unit then subsequently ensure a lifting of the uppermost part. After the lifting, the slide moves in the run-though direction to a depositing location for the unstacked part.

### SUMMARY

It is the object of the invention to provide an apparatus and a method for unstacking plate-like parts, concerning which apparatus or method the bringing-out is yet increased further compared to the state of the art and the quality and the reliability of the unstacking procedure is improved.

This object is achieved by an apparatus with the features described herein as well as by a method with the features described herein.

The apparatus according to the invention for unstacking plate-like parts, according to one non-limiting embodiment is characterised in that the gripping units can be displaced relative to one another and relative to the carrier structure in the run-through direction and can be positioned into different working positions by way of a motoric gripping unit drive device of the unstacking slide.

By way of this, it is possible to position the gripping units to one another such that an optimal distance of the gripping units to one another for the gripping and lifting of the parts is adjusted in dependence on the dimensions of the parts which are to be unstacked. The adjusting of the gripping units to one another and relative to the carrier unit can be carried out before the lifting of each individual part, wherein as a rule the parts which are located in the part stack, in particular sheet metal blanks, essentially have the same dimensions. The invention particularly excels given the change to another part stack with differently dimensioned parts, since the gripping units can be newly orientated to one another, so that an optimal gripping and lifting of the parts of the new part stack is also possible.

Concerning a further development of the invention, the motoric gripping unit drive device comprises several gripping unit drives which are each assigned to one of the gripping units. Particularly preferably, at least components of the gripping unit drive are located on board the assigned gripping unit.

Although in principle it would also be possible to provide a central gripping unit drive device which then via a gear drives the respective gripping units individually and independently of one another, it is however advantageous if the motoric gripping unit drive device comprises several gripper drives which are expediently located at least partly on board the assigned gripping units.

In a particularly preferred manner, a control device for the control of the gripping unit drives is present. Expediently, the control device is designed in a manner such that the gripping unit drives can be controlled independently of one another. The control device can be for example a superordinate control device, for example an SPS control which for example is arranged externally of the unstacking apparatus and transmits the control signals to the different gripping device drives, in particular in a wireless manner.

Concerning a further development of the invention, the carrier structure of the unstacking slide is designed as a guide rail which is aligned in the run-though direction and on which the gripping units are movably guided given their displacement.

In a particularly advantageous manner, the gripping unit drives are designed in particular as electrical linear drives. However, other types of linear drives are also conceivable, for example fluidic, in particular pneumatic linear drives.

Expediently, the linear drive is a linear direct drive with the guide rail as a stator and the gripping units as the rotor.

In a particularly preferred manner, the carrier device comprises several runner rails which are orientated parallel to one another in the run-through direction and at a distance to one another in the transverse direction to the run-through direction and on which at least one unstacking slide is movably guided between the supply station and the function station. Expediently, unstacking slides operate on different runner rails and herewith interact together with the gripping units which are arranged thereon, on unstacking and with the subsequent deposition of the parts.

It is particularly preferable for unstacking slides which are guided on runner rails which are adjacent one another in the transverse direction to the run-through direction to be controlled into movements which are in opposite directions to one another, in a manner such that if the one unstacking slide is located over the supply station, the adjacent other unstacking slide is located at the function station and vice versa.

Concerning the function station, this for example can be a conveying belt which transports the deposited parts further for the further processing. However, a centring station for centring the deposited parts or a part washing machine or a part oiling facility or a forming press can also serve as a function station.

Concerning a further development of the invention, the unstacking device comprises a runner rail drive device for adjusting the distance of the runner rails to one another in the transverse direction.

In a particularly preferred manner, the runner rail drive device comprises several runner rail drives which are each assigned to one of the runner rails.

The runner rail drive device in combination with the gripping unit drive device permits the adjusting of an individual gripping head pattern which is matched to the dimension of the part to be unstacked, in a plane which is spanned by the run-through direction and the transverse direction to the run-through direction. The gripping heads can be arbitrarily positioned to one another within this plane in dependence on the range of the travel path of the gripping units and of the runner rails. Such a gripping head displacing unit could also be denoted as a universal tooling.

In a particularly preferred manner, the runner rail drives can be controlled independently of one another by way of the control device, for the transverse adjusting of the runner rails independently of one another.

Concerning a further development of the invention, the unstacking device comprises a slide transverse drive device for the transverse displacing of the carrier structure with the gripping units with respect to the assigned runner rail. By way of this, it is possible for oppositely driven unstacking slides to evade one another.

Expediently, the slide transverse drive device comprises several slide transverse drives which are each assigned to one of the unstacking slides. Particularly preferably, the slide transverse drives are controllable independently of one another by way of a control device into transverse movements of the unstacking slides which are independent of one another.

The apparatus according to the invention for unstacking plate-like parts according to one non-limiting embodiment is characterised in that the unstacking device comprises a runner rail drive device for adjusting the distance of the runner rails to one another in the transverse direction.

By way of this, the distance of the gripping heads to one another in the transverse direction can be adjusted, by which means a gripping head pattern which is matched in dependence on the dimensions of the part to be unstacked can be adjusted in the transverse direction, so that the uppermost part can be securely gripped and lifted.

It is to be noted that the displacement of the gripping units to one another in combination with the displacement of the runner rails in the transverse direction is not absolutely necessary. Already, the displacement of the gripping units relative to one another or the displacement of the runner rails to one another in the transverse direction permits an unstacking of the parts from the part stack which is improved compared to the state of the art. The combined movement of the displacement of the gripping units to one another and the transverse displacement of the runner rails however achieves an even better result on unstacking.

Concerning a further development of the invention, the gripping units are designed as suction grippers with a gripping head which is designed as a suction head. Alternatively, it would be conceivable to design the gripping units as magnet grippers with a gripping head which is designed as a magnet head.

Concerning the parts which are to be unstacked, these are preferably plate-like parts, in particular sheet metal blanks. Gripping heads which are designed as suction grippers provide the advantage of also being able to unstack non-magnetic parts, for example aluminium sheet metal blanks.

In a particularly preferred manner, the carrier device comprises several beams which are orientated parallel to one another along a run-through direction and at a distance to one another in the transverse direction to the run-through direction, on which beams an assigned runner rail is fastened. The beams can be designed for example in a T-like or I-like manner.

In a particularly preferable manner, two runner rails are each fastened to the beams. Such an arrangement with two runner rails on the beams and unstacking slides assigned to the runner rails can also be denoted as a double feeder unit. Expediently, the runner rails are aligned to one another with an offset in the run-through direction.

In a particularly preferred manner, the runner rail drive device is coupled to the beams in a manner such that the beams can be displaced in the transverse direction for adjusting the distance of the runner rails in the transverse direction.

In a particularly preferred manner, the unstacking device comprises a slide longitudinal drive device for driving the unstacking slides in the run-through direction along the assigned runner rail between the supply station and the function station. Expediently, the slide longitudinal drive device comprises several slide longitudinal drives which are each assigned to an unstacking slide.

Particularly preferably, the unstacking slides can be controlled independently of one another by way of the control device, into longitudinal movements in the run-though direction which are independent of one another.

In a particularly preferred manner, the unstacking device comprises a gripping head drive device for moving the gripping heads in the height direction. Expediently, the gripping head drive device comprises several gripping head drives.

Particularly preferably, the gripping head drives are each assigned to one of the gripping units and in particular are located on board the respective gripping unit.

The method according to the invention for unstacking plate-like parts amid the use of an apparatus according to the embodiments described herein comprises the following steps:
determining the dimensions of the uppermost part of the part stack which is to be unstacked and transferring the determined dimensional data to the control device,
positioning the at least one unstacking slide over the part to be unstacked,
controlling the gripping unit drive device in dependence on the determined dimensions of the uppermost part for adjusting a suitable gripping distance of the gripping heads to one another for the lifting of the uppermost part and adjusting the gripping distance by way of moving the gripping units relative to one another in the run-through direction,
applying the gripping heads onto the uppermost part and lifting the part out of the part stack.

Concerning a further development of the method, several unstacking slides are positioned together over the part to be unstacked and the gripping unit drive device and the runner rail drive device are controlled in dependence on the determined dimensions of the uppermost part in a manner such that the gripping heads of the unstacking slides are moved together relative to one another in a plane which is spanned by the run-through direction and a transverse direction to the run-through direction, into a two-dimensional gripping head pattern which is suitable for the lifting of the uppermost part.

### BRIEF DESCRIPTION OF THE DRAWINGS

A preferred embodiment example of the invention is represented in the drawing and is explained hereinafter in more detail. In the drawing are shown in:

FIG. 1 a preferred embodiment example of the apparatus according to the invention for unstacking plate-like parts, integrated into a press line,

FIG. 2 a plan view of the unstacking apparatus according to the invention,

FIG. 3 a front elevation of the unstacking apparatus of FIG. 2,

FIG. 4 a lateral view upon a beam of the unstacking apparatus of FIG. 2, wherein the runner rails and the unstacking slides which are arranged thereon are shown,

FIG. 5 a plan view of the beam of FIG. 4,

FIG. 6 an enlarged representation of the detail X from FIG. 4,

FIG. 7 a section through the unstacking slides of FIG. 6 along the line VII-VII in FIG. 6,

FIG. 8 a perspective representation of a runner rail with an unstacking slides which is arranged thereon, according to the arrangement of FIG. 4 and

FIG. 9 a front elevation of the beam with the runner rails and of the unstacking slides of FIG. 4 which are arranged thereon.

### DETAILED DESCRIPTION

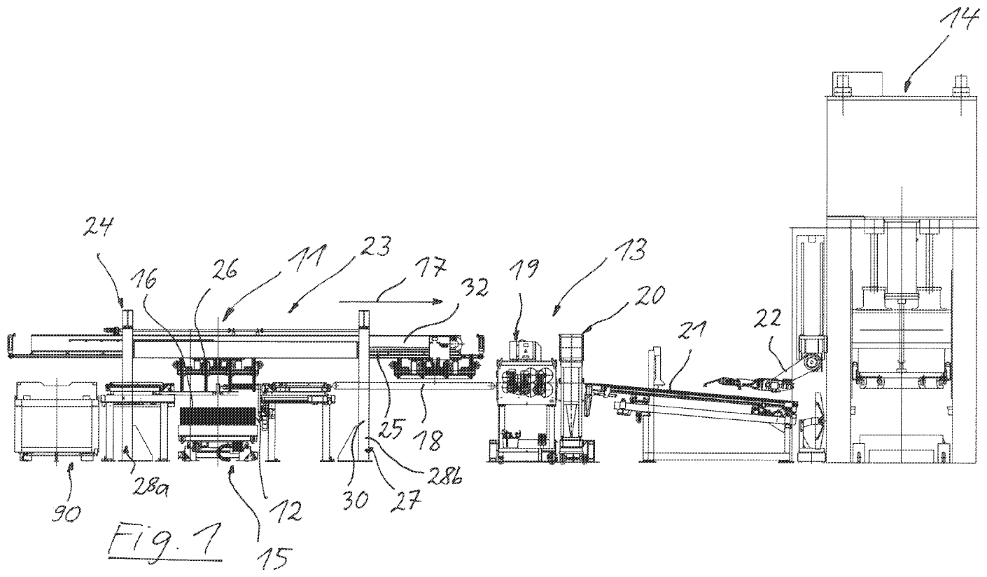

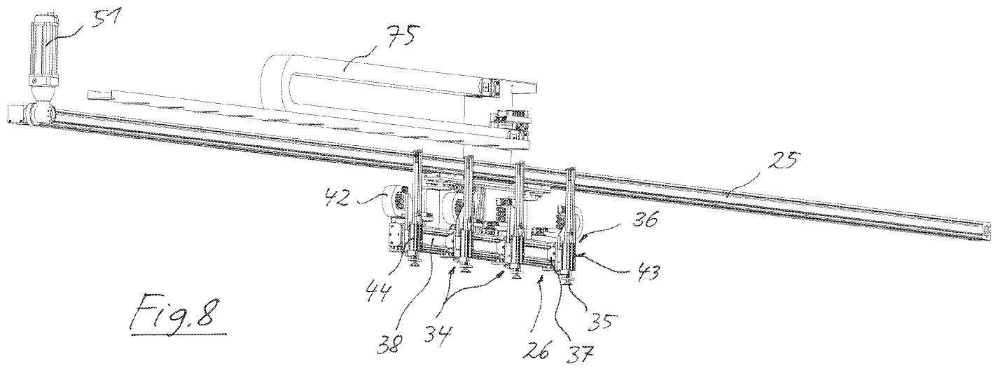

FIGS. 1 to 9 show a preferred embodiment example of the apparatus 11 according to the invention for unstacking plate-like parts 12. The apparatus 11 is hereinafter described by way of example as a constituent of a press line 13 which serves for de-stacking the stacked-in parts 12 in the form of sheet metal blanks, in particular car body sheets and reshaping them in a forming press 14.

The press line 13 by way of example comprises a supply station 15 in which the parts 12, thus sheet metal blanks, are stacked. The supply stations 15 are in process, which means that parts 12 which are stacked in this are de-stacked by the apparatus 11. If e.g. two sheet metal blanks cannot be singularised, then these are ejected into a container 90.

The transport of parts in the press line 13 is effected along a run-through direction 17 with the end station of the forming press 14.

In the shown example case, a part 12 after the unstacking or lifting out of the part stack 16 is moved in the run-through direction 17 to a conveying belt 18 and is deposited thereon.

A washing machine 19 and an oiler 20 connect onto the conveying belt 18 in the run-through direction. The parts are cleaned in the washing machine 19 and are oiled in the oiler 20.

After the oiler 20, the purified and oiled parts 12 get onto a further conveying belt 21 where they are then gripped by an inserting unit 22 in the form of a robot, in particular articulated arm robot and are inserted into the forming press 14. The invention which is described hereinafter in a detailed manner, relates to the apparatus 11 for unstacking the parts 12.

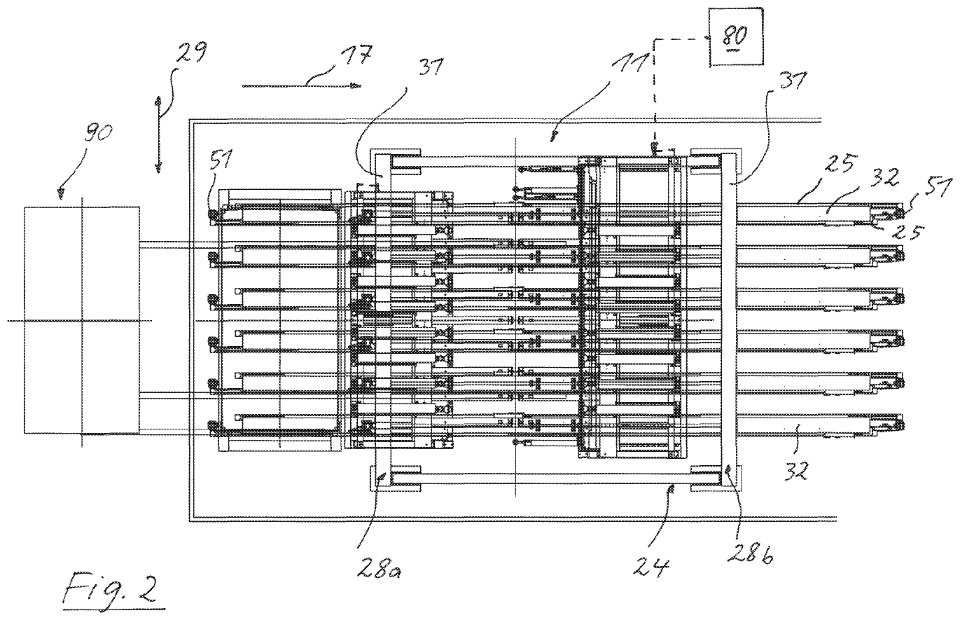

As is particularly shown in FIGS. 1 and 2, apart from the already mentioned supply station 15, the apparatus 11 comprises an unstacking device 23 for the singularised unstacking of the part stack 16 and for bringing an unstacked part 12 along the run-through direction 17 onto a function station which is arranged downstream and in the example case is therefore the conveying belt 18.

The unstacking device 23 according to the embodiment example is designed in a portal construction manner and comprises a carrier device 24 with at least one runner rail 25 which is aligned along the run-through direction and on which an unstacking slide 26 is movably guided in the run-through direction 17 between the supply station 15 and the function station, in particular the conveying belt 18.

As is particularly shown in FIGS. 1 and 2, the carrier device 24 comprises a mount 27 which comprises two mount bridges 28a, 28b which are arranged distanced to one another in the run-through direction 17 and bridge the conveying belt 18 or the supply station 15 in a portal-like manner. The mount bridges 28a, 28b each consist of two vertical pillars 30 which in a transverse direction 29 to the run-through direction 17 are arranged to the left and right of the supply station 15 or of the conveying belt 21 and which are connected to one another in the transverse direction 29 by way of a transverse beam 31.

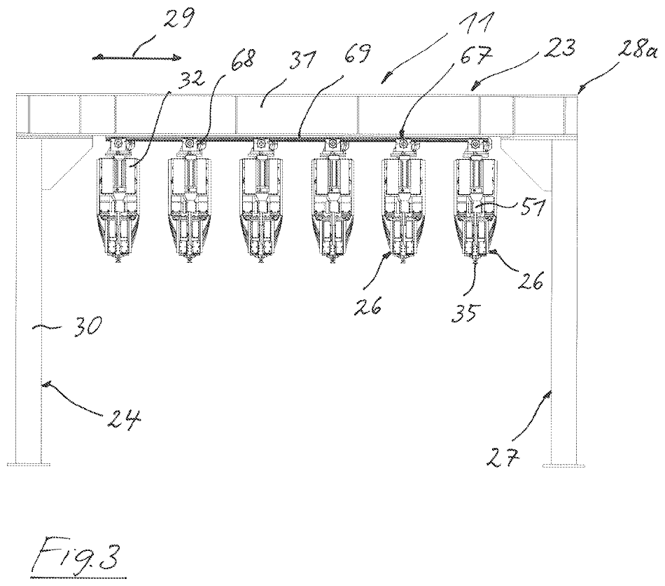

As is particularly shown in FIGS. 2 and 3, several beams 32 which are arranged parallel to one another in the run-through direction 17 and are aligned at a distance to one another in the transverse direction 29 and which can also be denoted as longitudinal beams are arranged on the two transverse beams 31 of the mount bridges 28 in a manner which is described in more detail hereinafter.

As in particular FIG. 3 shows, two runner rails 25 which are arranged parallel to one another in the run-through detection and on which an unstacking slide 26 is movably guided are arranged on each beam 32. The runner rails 25 are fastened to the assigned beam 32 with an offset in the run-through direction 17.

The unstacking slides 26 each comprise a carrier structure 33, on which several gripping units 34 are arranged, wherein the gripping units 34 each comprise at least one gripping head 35 which can be displaced in the height direction for lifting the parts 12 out of the part stack 16. The gripping units 34 in the example are designed as suction grippers and comprise a gripping head 35 which is designed as a suction head. The lifting of the uppermost part 12 of the part stack 16 is therefore effected by way of suction heads being brought to bear onto the upper side of the part 12 to be unstacked and a vacuum within the suction head being subsequently generated, which leads to a fixed sucking of the suction head on the upper side of the part 12 to be lifted, so that the part 12 can be lifted from the part stack 16.

The vacuum generation of the suction grippers can be effected for example by way of a venturi nozzle or by a vacuum pump.

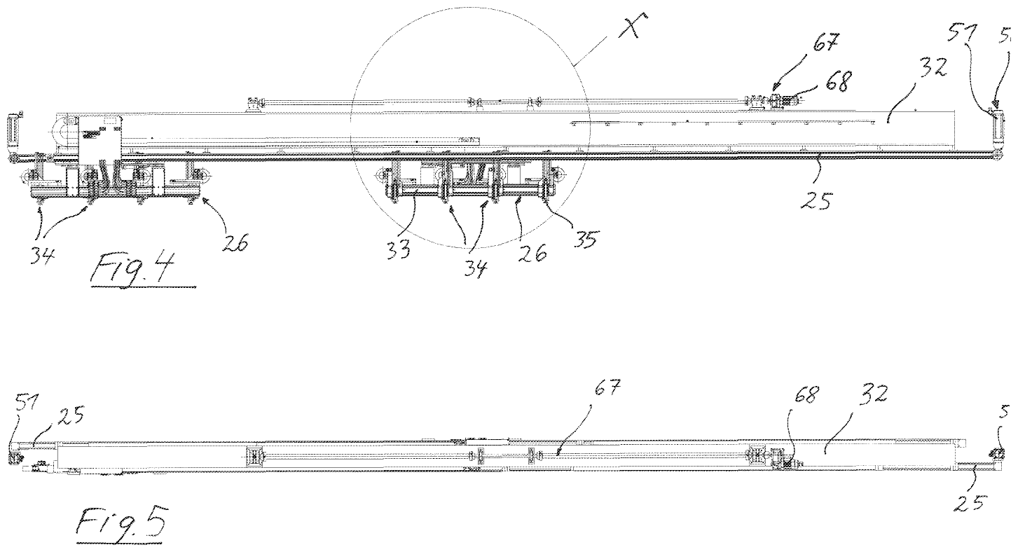

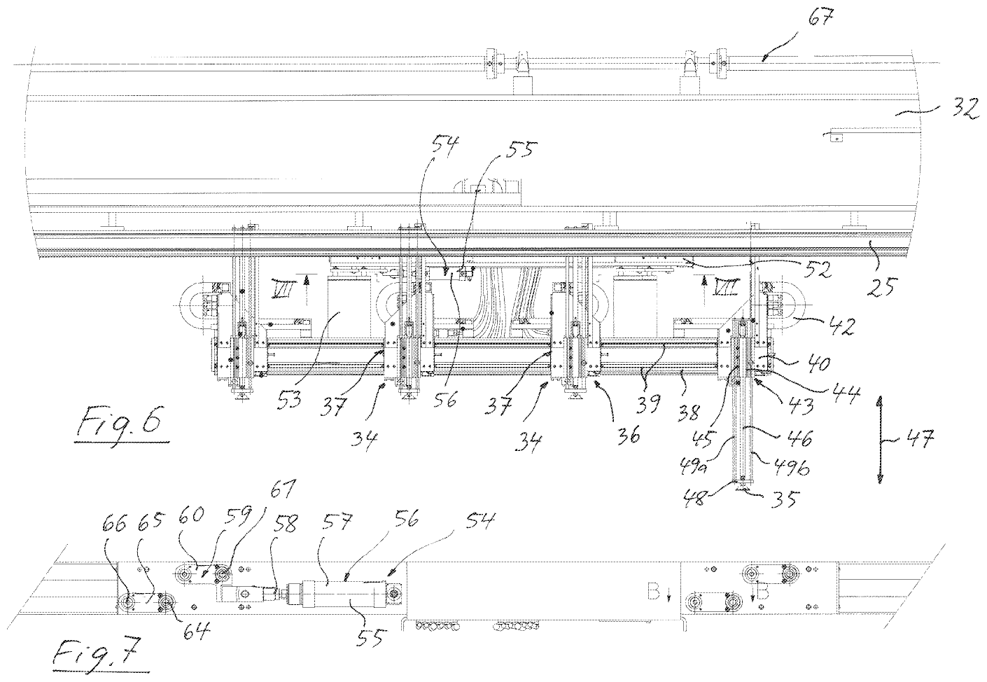

In particular, FIGS. 4 and 6 together show that several gripping units 34 which are arranged on the carrier structure 33 one after other in the run-through direction 17 are arranged on the unstacking slide 26. The unit of the beam 32, the two runner rails 25 which are fastened thereto and the unstacking slides 26 which are movably guided thereon with the gripping units 34 and the gripping heads 35 can also be denoted as a “double feeder”.

Important components of the apparatus 11 for unstacking the parts 12 are several drives with which the different components of the device 11 can be movably guided and positioned in different directions, which is described in more detail hereinafter:

Whereas with conventional unstacking slides the gripping units 34 and the gripping heads which are arranged thereon are fastened to the assigned carrier structure in a positionally fixed manner, the gripping units 34 now according to the invention are displaceable relative to one another and relative to the carrier structure 13 in the run-through direction 17 and can be positioned into different working positions by way of a motoric gripping unit drive device 36 of the unstacking slide 26.

As is particularly shown in FIG. 6, the motoric gripping unit drive device comprises several gripping unit drives 37 which are each assigned to one of the gripping units 34. At least components of the gripping unit drives 37 are located on board the assigned gripping units 34.

As is particularly shown in FIG. 6, the carrier structure 33 of the unstacking slide 26 is designed as a guide rail 38, on which the gripping units 34 are movably guided in the run-through direction. The gripping unit drives 37 can be designed as electrical linear drives. By way of example, what is shown in an electrical linear direct drive, concerning which the guide rail 38 is designed as a stator and the gripping units 34 as a rotor.

As is further shown in FIG. 6, the guide rail 38 of the unstacking slide 26 comprises two guide tracks 39 which are aligned above one another in the height direction and extend parallel to one another in the run-through direction 17. The gripping units 34 each comprise a base housing 40, on whose rear side two sliding pieces which project into the guide tracks 39 engage. Furthermore, a coil (not shown) which can be subjected to current is located in the base housing 49.

Furthermore, a control device 80 (FIG. 2) for controlling the gripping unit drives 37 is provided, concerning which it is expediently an external control device 80 which is located outside the apparatus 11 and which outputs control signals to the individual gripping unit drives 37. In the specific case, the control signals initiate current subjection of the coils in the gripping units 34, by way of which a movement of the gripping units along the guide rail in the guide tracks 39 can take place on account of the permanent magnets which are arranged in the guide rail 38. Each gripping unit further comprises a trailing cable device 42 which on the one hand is arranged on the guide rail 38 and on the other hand on the base housing 40.

As is further shown in FIG. 6, apart from the gripping unit drive device 36, a gripping head drive device 43 for moving the gripping heads 35, in the shown exemplary case suction heads, is present in the height direction. The gripping head drive device 43 comprises several gripping head drives 44 which are located on board the gripping units 34.

The gripping head drives by way of example are shown in the form of electrical linear drives.

The linear drive which is shown by way of example as a gripping head drive 44 comprises a drive housing 45, in which a rotor 45 is movably guided in the height direction 47. The rotor 46 at its free end is connected to a coupling piece 48, on whose lower side the gripping head 35 which is designed as a suction head is fastened. The drive further comprises two guide rods 49a, 49b which are arranged to the left and right of the rotor 46 and extend parallel to this. The guide rods 49a, 49b serve for the rotation locking of the coupled-on suction head. The guide rods are likewise movably guided in the drive housing 45 and are fastened with their free ends to the coupling piece 48.

The gripping head drives 44, thus in particular the shown linear drives are controllable likewise independently of one another via the control device 80, so that the lowing and lifting movement of the suction heads can take place independently of one another. Above all, this is advantageous for the lifting procedure of the parts from the part stack 16, said procedure being yet described in more detail hereinafter.

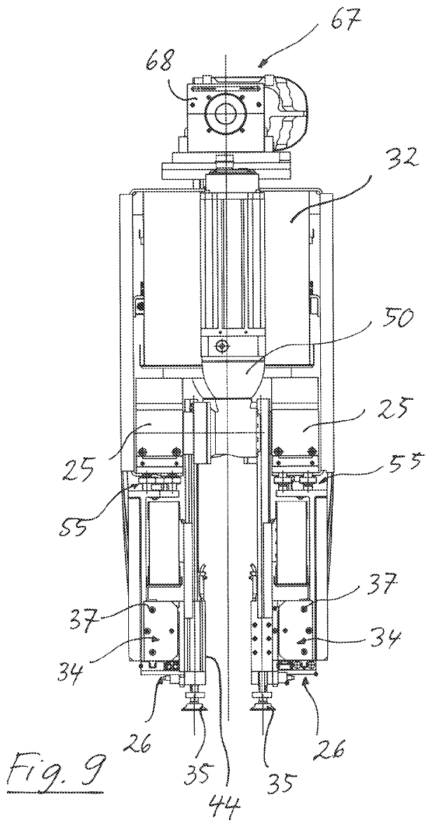

The unstacking device 23 further comprises a slide longitudinal drive device 50 for driving the unstacking slide 26 along the assigned runner rail 25 in the run-through direction 17 between the supply station 15 and the function station, thus in particular the conveying belt 18. The slide longitudinal drive device 50 comprises several slide longitudinal drives 51 which are each assigned to one of the unstacking slides. As is particularly shown in FIGS. 8 and 9, two runner rails 25 are fastened parallel to one another, to the carrier 32. As is particularly shown in FIG. 4, the runner rails are arranged offset to one another in the run-through direction 17. The slide longitudinal drives 51 are seated on one end of the runner rail 25. Herein, the slide longitudinal drive 51 of the one runner rail 25 is seated at the one end and the slide longitudinal drive of the other unstacking slide 26 opposite this at the other end of the other runner rail 25. The lateral offset of the runner rails 25 which are arranged on an assigned carrier 32, in the run-through direction permits the arrangement of the slide longitudinal drives 51 laterally next to the assigned longitudinal rail.

The slide longitudinal drives 51 by way of example are shown as linear drives in the form of servo-motors.

As is particularly shown in FIG. 8, the unstacking slides 26 each comprise a runner vehicle 52 which engages into the guide tracks (not shown) of the assigned runner rail 25 and is guided thereon along the runner rail 25. Two vertical struts 53 which are orientated distanced to one another in the run-through direction and which extend in the height direction are fastened to the runner vehicle via coupling means 54. The already mentioned carrier structure 33 in the form of the guide rail 38 for the gripping units 34 is located on the free ends of the vertical struts 53. As is particularly shown in FIG. 4, a trailing cable device 54 which is guided along a cable trailing rail 55 (FIG. 8) is arranged on the runner vehicle 52. The trailing cable device 75 permits the electrical supply of the components of the unstacking slide 26 despite the movement of the unstacking slide 26 in the run-through direction 17.

The unstacking device 23 further comprises a slide transverse drive device 54 for the transverse displacement of the carrier structure with the gripping units 34 with respect to the assigned runner rail 25. The slide transverse drive device 54 comprises several slide transverse drives which are each assigned to one of the unstacking slides 26.

The aforementioned slide longitudinal drives 51 as well as the slide transverse drives 55 can be individually controlled by the control device, so that the unstacking slides 26 can be displaced independently of one another in the run-through direction along the assigned runner rail and additionally independently of one another in the transverse direction 29 transverse to the run-through direction 17. By way of the transverse movement of the unstacking slide which can be produced by the slide transverse drives 55, it is possible for the unstacking slides 26 which are driven in opposite directions to evade one another on an assigned carrier 32. In particular, the unstacking slide which is not loaded evades the unstacking slide which is loaded with a part, by way of a transverse movement. The unstacking slide 26 which is not loaded, after passing the loaded unstacking slide, can then change back into the same track as the loaded unstacking slide, so that the positions of the gripping heads 35 above the part to be lifted can be set in an exactly equal manner as the position of the other unstacking slide. The gripping heads 35 of the unstacking sides 26 of a unit (carrier with two unstacking slides) can therefore always grip at the same position. However, it would also be conceivable for the runner rails 25 of a unit to be distanced to one another in the transverse direction 29 in a manner such that the unstacking slides 29 pass one another. In this case, no slide transverse drive device 54 would be necessary. The position of the gripping heads 35 on gripping the one unstacking slide 26 would be different from the position of the gripping heads 35 on gripping the other unstacking slide 26.

The slide transverse drives 55 each comprise a drive unit which is arranged on the lower side of the runner vehicle 52.

The drive unit 56 by way of example is shown in the form of a fluid, in particular pneumatic linear drive. The pneumatic linear drive comprises a pneumatic cylinder which comprises a cylinder housing 57 in which a piston is guided in a movable manner by way of subjection to pressurised air. The piston is connected to a position rod 58 which is led out of the cylinder housing 57 and is connected to the coupling means which have already been mentioned above. The coupling means comprise lever gears 59 which on the one hand are connected to the piston rod 58 and one the other hand are connected to an assigned vertical strut 53. The lever gears 59 each comprise a first lever 60 which on the one hand is connected to the piston rod 58 of the pneumatic cylinder and is pivotably mounted on the runner vehicle 532 about a pivot axis 61. The first lever at its free end which is opposite to the end which is connected to the piston rod comprises a joint 62, on which a connection lever is articulated. The connection lever is connected via a further joint 64 to a second lever 65 which at the end side is mounted on the runner vehicle via a further pivot axis 66. An identically constructed lever gear 59 is assigned to the other vertical strut 53, so that given a pressure impingement of the piston and for example an extension of the piston rod as a whole a type of parallelogram gear arises, and this ensures that the coupled vertical struts 53 and herewith the carrier structure 33 with the gripping units 34 is displaced transversely to the runner rail 25 and herewith in the transverse direction 29.

The unstacking device 23 further comprises a runner rail drive device 67 for adjusting the distance of the runner rails 25 to one another in the transverse direction 29. The runner rail drive device 67 comprises several runner rail drives 68 which are each assigned to one of the runner rails 25. The runner rail drives 68 can also be individually activated by the control device 80 so that the distance of the runner rails 25 to one another in the transverse direction 29 can be changed.

As is particularly shown in FIGS. 1 and 2, it is not the runner rails 25 per se which are displaced in the transverse direction 29 by way of the runner rail drive device 67, but the beams 32, on which in the exemplary case two runner rails 25 are arranged. As is particularly shown in FIG. 3, guide rails 68 on which the carriers are movably guided in the transverse direction 29 are arranged on the lower sides of the transverse beams 31 of the mount bridges 28.

As shown by way of example in FIG. 3, a runner rail drive 68 in the form of a linear motor is assigned to each carrier 32.

On unstacking plate-like parts 12, in particular sheet metal blanks from a part stack 16, one proceeds as follows:

The parts 12 are firstly located in the supply station 15 in a manner stacked above one another into a part stack 16. The parts are sheet metal blanks, for example car body parts which can indeed have dimensions of several square metres. For this reason, several unstacking slides 26 which interact are necessary for unstacking the parts 12.

Firstly, the dimension of the uppermost part 12 of the part stack 16 is determined. The determined dimensional data, concerning which it can not only be a surface, but also an arching, is then transferred to the control device 80. The control device 80 then controls the different drive devices.

Firstly, the slide longitudinal drives 51 are activated, so that one of the slides of the double slide system or of the “double feeder” is placed above the part to be unstacked. As a whole therefore, several unstacking slides 26 are positioned together above the part 12 to be unstacked. The other unstacking slides 26 which each run on the other runner rail 25 of the same carrier 32 are simultaneously located in the region of the further function station, thus of the conveying belt 18 and are ready to deposit a commonly unstacked and gripped part 12 onto the conveying belt 18.

The unstacking slides 26 which are positioned above the part 12 to be unstacked, with their gripping units 34 and the gripping heads 35 which are arranged thereon form a two-dimensional gripping head pattern in a plane which is spanned by the run-through direction 17 and the transverse direction 29.

Before the lifting procedure of the uppermost part 12 out of the part stack 16 begins, the gripping heads 35 are positioned to one another in a manner such that a gripping head pattern which is optimal for the lifting is adjusted in dependence on the dimensions of the part 12 which is to be unstacked.

The gripping unit drives 37 are therefore activated by the control device 80, so that the gripping units 34 and thus the coupled-on gripping heads 35 are positioned and distanced relative to one another in the run-through direction 17 so that the positions of the gripping heads 35 in the run-through direction 17 are optimal for the lifting of the part. Furthermore, the runner rail drives 68 are activated, by which means the carriers 32 which are movably guided on the guide rails 69 which are formed on the transverse beams 31 can be positioned relative to one another so that the distance of the gripping heads 35 can also be changed in the transverse direction. Since in any case only one of the unstacking slides 26 of the double slide arrangement is in operation on unstacking and the other unstacking slide is located in the region of the conveying belt 18, it is insignificant that on displacing the beams 32, the other unstacking slides which are located above the conveying belt are also co-displaced together. The transverse displacement of the gripping heads 35 as a rule is effected only a single time per part stack 16.

After adjusting this gripping head pattern which is optimal for the lifting, the gripping head drives 44 are subsequently activated, so that the gripping heads 35 in the form of suction heads come to bear on the upper side of the part 12 to be lifted.

In the exemplary case, the suction heads are then evacuated, which is to say a vacuum is produced, so that the suction heads are fixedly sucked to the uppermost part 12. The lifting of the part can herein be effected by way of simultaneously moving up the gripping heads 35 or in a preferred manner by way of the staggered lifting-up of different gripping heads, as is described for example in DE 101 17 607 B4. Herein, the gripping heads 35 during the lifting procedure can each execute a movement with movement phases which become fastener and slower, wherein the movements of the different gripping heads 35 are asynchronous to one another, so that a continuously changing, wave-like deformation of the part which is held by the gripping heads 35 results during the lifting procedure, by which means the uppermost part can be released more easily from the rest of the part stack 16.

After lifting the uppermost part 12, the gripping heads 35 of the unstacking slides 26 move together into a transport position. The slide longitudinal drives 51 are subsequently activated, so that the unstacking slides move together to the conveyor belt 18. At the same time, the unstacking slides which had previously been located above the conveying belt 18 are moved in the direction of the supply station 18. In order to avoid a collision of the unstacking slides which are driven in opposite directions, in particular in the region of a double-slide arrangement, the slide transverse drives 55 are activated, so that one of the unstacking slides 26, in particular the one which is not loaded can evade in the transverse direction 29. As soon as the unstacking slides 26 which are loaded with the singularised part 12 are arranged above the conveying belt 18, the gripping heads 35 together are moved downwards to an ejection height and the part is deposited by way of introducing a pressure impulse onto the gripping heads 35. At the same time, a renewed stacking of the uppermost part 12 is effected at the supply station by way of the unstacking slide 26 which is located there. By way of the displaceability of the gripping heads 35 to one another in the run-through direction and in the transverse direction 29, the griping head pattern can be individually changed and adapted to different dimensions of the parts which are to be unstacked.

1. An apparatus for unstacking plate-like parts, with at least one supply station, in which at least one part stack of plate-like parts is located and with an unstacking device which is assigned to the supply station and is for the singularised unstacking of the part stack and for bringing an unstacked part along a run-through direction onto a function station which is arranged downstream,
wherein the unstacking device comprises a carrier device with at least one runner rail which is aligned along the run-through direction and on which an unstacking slide is movably guided in the run-through direction between the supply station and the function station,
wherein the unstacking slide comprises a carrier structure on which a plurality of gripping units are arranged,
wherein the gripping units each comprise at least one gripping head which can be moved in the height direction for lifting the parts out of the part stack, and
wherein the gripping units can be displaced relative to one another and relative to the carrier structure in the run-through direction and can be positioned into different working positions, by way of a motoric gripping unit drive device of the unstacking slide.

2. An apparatus according to claim 1, wherein the motoric gripping unit drive device comprises a plurality of gripping unit drives which are each assigned to one of the gripping units, wherein at least components of the gripping unit drive are located on board the assigned gripping unit.

3. An apparatus according to claim 2, further comprising a control device for the control of the gripping unit drives, wherein the control device is designed in a manner such that the gripping unit drives can be controlled independently of one another.

4. An apparatus according to claim 1, wherein the carrier structure of the unstacking slide is a guide rail which is aligned in the run-though direction and on which the gripping units are movably guided given their displacement.

5. An apparatus according to claim 2, wherein the gripping unit drives are electrical linear drives.

6. An apparatus according to claim 5, wherein the linear drives are linear direct drives with the guide rail as a stator and the gripping units as the rotor.

7. An apparatus according to claim 1, wherein the carrier device comprises a plurality of runner rails which are orientated parallel to one another in the run-through direction and at a distance to one another in the transverse direction to the run-through direction and on which an unstacking slide is movably guided between the supply station and the function station.

8. An apparatus according to claim 7, wherein unstacking slides which are guided on runner rails which are adjacent to one another in the transverse direction to the run-through direction are controlled into a movement which is opposite to one another, in a manner such that if the one unstacking slide is located over the supply station, the other unstacking slide is located at the function station and vice versa.

9. An apparatus according to claim 7, wherein the unstacking device comprises a runner rail drive device for adjusting the distance of the runner rails to one another in the transverse direction.

10. An apparatus according to claim 9, wherein the runner rail drive device comprises a plurality of runner rail drives which are each assigned to one of the runner rails, wherein the runner rail drives can be controlled independently of one another by way of the control device, for the transverse adjusting of the runner rails independently of one another.

11. An apparatus according to claim 1, wherein the unstacking device comprises a slide transverse drive device for the transverse displacement of the carrier structure with the gripping units with respect to the assigned runner rail.

12. An apparatus according to claim 11, wherein the slide transverse drive device comprises a plurality of slide transverse drives which are each assigned to one of the unstacking slides, wherein the slide transverse drives are controllable independently of one another into the transverse movements of the unstacking slides which are independent of one another, by way of a control device.

13. An apparatus for unstacking plate-like parts, with at least one supply station, in which at least one part stack of plate-like parts is located and with an unstacking device which is assigned to the supply station, for the singularised unstacking of the part stack and bringing an unstacked part along a run-through direction onto a function station which is arranged downstream,
wherein the unstacking device comprises a carrier device with a plurality of runner rails which are orientated parallel to one another along a run-through direction and at a distance to one another in a transverse direction to the run-through direction and on which an unstacking slide is movably guided in the run-through direction between the supply station and the function station,
wherein the unstacking slide comprises a carrier structure, on which a plurality of gripping units are arranged,
wherein the gripping units each comprise at least one gripping head which can be moved in the height direction for lifting the parts out of the part stack, and
wherein the unstacking device comprises a runner rail drive device for setting the distance of the runner rails to one another in the transverse direction.

14. An apparatus according to claim 13, wherein the runner rail drive device comprises a plurality of runner rail drives which are each assigned to one of the runner rails.

15. An apparatus according to claim 13, wherein the apparatus is designed according to claim 1.

16. An apparatus according to claim 1, wherein the gripping units are suction grippers with a gripping head which is a suction head.

17. An apparatus according to claim 1, wherein the carrier device comprises a plurality of beams designed in an I-like manner, which are orientated parallel to one another along a run-through direction and at a distance to one another in the transverse direction to the run-through direction, on which beams an assigned one of the runner rails is fastened.

18. An apparatus according to claim 17, wherein two runner rails are each fastened to the beams with an offset to one another in the run-through direction.

19. An apparatus according to claim 17, wherein the runner rail drive device is coupled to the beams in a manner such that the beams can be displaced in the transverse direction for setting the distance of the runner rails in the transverse direction.

20. An apparatus according to claim 1, wherein the unstacking device comprises a slide longitudinal drive device for driving at least one unstacking slide in the run-through direction along the assigned runner rail between the supply station and the function station, wherein the slide longitudinal drive device comprises a plurality of slide longitudinal drives which are each assigned to one unstacking slide, wherein the unstacking slides can be controlled independently of one another into longitudinal movements in the run-though direction which are independent of one another, by way of a control device.

21. An apparatus according to claim 1, wherein the unstacking device comprises a gripping head drive device for moving the gripping heads in the height direction, wherein the gripping head drive device comprises a plurality of gripping head drives which are each assigned to one of the gripping units and located on board the gripping units.

22. A method for unstacking plate-like parts using the apparatus according to claim 1, the method comprising the following steps:
determining the dimensions of the uppermost part of the part stack which is to be unstacked and transferring the determined dimensional data to a control device,
positioning the at least one unstacking slide over the part to be unstacked,
controlling the gripping unit drive device in dependence on the determined dimensions of the uppermost part for setting a suitable gripping distance of the gripping heads to one another for the lifting of the uppermost part and adjusting the gripping distance by way of displacing the gripping units relative to one another in the run-through direction,
applying the gripping heads onto the uppermost part and lifting the part out of the part stack.

23. A method according to claim 22, wherein a plurality of unstacking slides are positioned together over the part to be unstacked and the gripping unit drive device and the runner rail drive device are controlled in dependence on the determined dimensions of the uppermost part in a manner such that the gripping heads of the unstacking slides are displaced together relative to one another in a plane which is spanned by the run-through direction and a transverse direction to the run-through direction, into a gripping head pattern which is suitable for the lifting of the uppermost part.
